(19) United States
(12) Patent Application Publication
(10) Pub. No.: US 2002/0154320 A1
(43) Pub. Date: Oct. 24, 2002

(54) Image data generation method, image data generation apparatus, image processing method, image processing apparatus, and recording medium

(76) Inventor: Makoto Kagaya, Kaisei-machi (JP)

Correspondence Address: BIRCH STEWART KOLASCH & BIRCH, PO BOX 747, FALLS CHURCH, VA, 22040-0747, US

(21) Appl. No.: 10/108,366

(22) Filed: Mar. 29, 2002

(30) Foreign Application Priority Data
Mar. 29, 2001 (JP) (PAT) 096143/2001

(51) Int. Cl. B41B 1/00; G06F 15/00

(52) U.S. Cl. 358/1.2

(57) ABSTRACT

Image processing in accordance with a resolution of an output device is carried out. Sharpness processing appropriate for reproduction on a 72-dpi monitor is carried out on image data obtained by a scanner. The image data after the processing are recorded in a recording medium by recording medium generation means. At this time, a parameter necessary for calculation of an enhancement factor of sharpness processing necessary for reproduction of the image data by a printer having resolution different from that of the monitor is added to the image data as accompanying information. A user carries out sharpness processing appropriate for the resolution of the printer by referring to the accompanying information, for reproduction of the image data recorded in the recording medium with the printer.

### BACKGROUND OF THE INVENTION

1. Field of the Invention

The present invention relates to an image data generation method and an image data generation apparatus for generating image data that have been subjected to image processing, and to an image processing method and an image processing apparatus for carrying out image processing on the image data generated by the image data generation method and the image data generation apparatus. The present invention also relates to a computer-readable recording medium storing a program that causes a computer to execute the image data generation method and the image processing method.

2. Description of the Related Art

There have been known digital photograph service systems for carrying out various kinds of digital photograph services such as storing image data generated by digitization of photographs obtained by users in image servers, recording the image data in recording media such as CD-Rs to be provided to the users, printing images photographed by users with digital cameras, and receiving orders for additional prints.

In a service for providing a user with a recording medium such as a CD-R having image data recorded therein, the user can reproduce images he/she photographed on a monitor of his/her personal computer. Furthermore, the user can insert a favorite image in his/her Web page or can send the favorite image to his/her friends or the like by attaching the image to an E-mail message. In this manner, such a service is preferred. Moreover, the user can print the image data recorded in the recording medium by using a printer of his/her own.

At the time of recording image data in a recording medium, the image data are subjected to image processing such as sharpness processing, tone processing, and rotation so that the quality thereof can be improved when the image data are reproduced. Therefore, a user can view an image in high quality by simply reproducing the image data recorded in the recording medium.

Meanwhile, each output device such as a monitor and a printer for reproducing the image data has a different resolution for image reproduction, depending on the model thereof. In the case where sharpness processing is carried out on the image data, sharpness and graininess of a reproduced image become different, depending on the resolution of the output device used for reproduction of the image data that have been subjected to the image processing. For example, if image data having been subjected to sharpness processing appropriate for reproduction on a 72-dpi resolution monitor are printed by a 300-dpi resolution printer, a reproduced image represented by the image data looks blurry. On the contrary, if image data having been subjected to sharpness processing appropriate for printing by a 300-dpi resolution printer are reproduced by a 72-dpi resolution monitor, a reproduced image represented by the image data has strong sharpness and high graininess. Therefore, in order to obtain a reproduced image that has been subjected to appropriate sharpness processing regardless of the resolution of an output device, the user needs to carry out sharpness processing on the image data in accordance with the resolution of the output device. However, such sharpness processing requires skill and is not easily carried out.

In some cases, image data having been subjected to sharpness processing appropriate for printing and image data having been subjected to sharpness processing appropriate for reproduction on a monitor are recorded in a recording medium to be provided to a user. However, since image data have a large size, considerably large memory space of the recording medium is occupied by the image data of the two types of sharpness processing.

### SUMMARY OF THE INVENTION

The present invention has been conceived based on consideration of the above circumstances. An object of the present invention is therefore to enable easy image processing in accordance with a resolution of an output device.

Another object of the present invention is to carry out image processing enabling reproduction of an image in a quality in accordance with a resolution of an output device.

An image data generation method of the present invention is a method of generating image data having been subjected to predetermined image processing appropriate for reproduction at a predetermined resolution, and the image data generation method comprises the step of:

adding image processing information regarding the predetermined image processing to the image data.

As the image processing information, any information such as information specifying the predetermined image processing carried out on the image data can be used, as long as the information is regarding the predetermined image processing. For example, a parameter used in the predetermined image processing (such as a sharpness enhancement factor if the predetermined image processing is sharpness processing) can be used as the image processing information. Instead of using the parameter itself, a parameter used in another type of image processing to be carried out on the image data for reproduction at a resolution different from the predetermined resolution, information used for calculating the parameter of the image processing of another type, a table or a graph regarding parameters in other types of image processing, an identifier such as a symbol or a number for specifying the table or the graph, and the predetermined resolution itself can be used as the image processing information, for example.

Adding the image processing information to the image data refers to recording the image processing information in tag information in an Exif image file if a file format of the image data is Exif, or relating a file of the image processing information to the image data recorded in a separate file, for example.

The image data maybe provided to the user by being recorded in a recording medium such as an FD, a CD-R, a DVD, an MO disc, or a ZIP disc. Alternatively, the image data may be provided to the user by being stored in a hard disc of an image server so that the user can download the image data via a network.

In the image data generation method of the present invention, it is preferable for the predetermined image processing to be sharpness processing. In this case, the image processing information is preferably related to a sharpness enhancement factor used in the sharpness processing.

As the information related to the sharpness enhancement factor, a value of the sharpness enhancement factor itself may be used. Alternatively, a sharpness enhancement factor used in another type of sharpness processing to be carried out on the image data for reproduction thereof at a resolution different from the predetermined resolution, information necessary for calculating the sharpness enhancement factor used in the sharpness processing of another type, a table or a graph regarding sharpness enhancement factors used in other types of sharpness processing, an identifier such as a symbol or a number for specifying the table or the graph, and the predetermined resolution itself can be used, for example.

A first image processing method of the present invention is a method of carrying out image processing different from the predetermined image processing on the image data generated by the image data generation method of the present invention, and the first image processing method comprises the step of:

carrying out the image processing that is different from the predetermined image processing on the image data based on the image processing information, in the case where the image data are reproduced at a resolution different from the predetermined resolution.

The image processing different from the predetermined image processing refers to image processing having a different degree of processing effect although the type of the image processing is the same as the predetermined image processing. For example, if the image processing is sharpness processing, the predetermined image processing uses a sharpness enhancement factor different from a sharpness enhancement factor of the image processing.

A second image processing method of the present invention is appropriate if the predetermined image processing used in the image data generation method is sharpness processing. The second image processing method is a method of carrying out sharpness processing on the image data generated by the image data generation method of the present invention, and the second image processing method comprises the step of:

carrying out the sharpness processing having an enhancement factor different from the enhancement factor used in the predetermined image processing on the image data based on the image processing information, in the case where the image data are reproduced at a resolution different from the predetermined resolution.

An image data generation apparatus of the present invention is an apparatus for generating image data having been subjected to predetermined image processing appropriate for reproduction of the image data at a predetermined resolution, and the image data generation apparatus comprises:

adding means for adding image processing information regarding the predetermined image processing to the image data.

In the image data generation apparatus of the present invention, it is preferable for the predetermined image processing to be sharpness processing. In this case, the image processing information is preferably information regarding an enhancement factor of the sharpness processing.

A first image processing apparatus of the present invention is an image processing apparatus comprising processing means for carrying out image processing different from the predetermined image processing on the image data generated by the image data generation apparatus of the present invention. The first image processing apparatus is characterized by that

the processing means carries out the image processing different from the predetermined image processing on the image data based on the image processing information in the case where the image data are reproduced at a resolution different from the predetermined resolution.

A second image processing apparatus of the present invention is appropriate if the image processing carried out by the image data generation apparatus is sharpness processing.

The second image processing apparatus comprises processing means for carrying out sharpness processing on the image data generated by the image data generation apparatus, and the second image processing apparatus is characterized by that the processing means carries out the sharpness processing having an enhancement factor that is different from the enhancement factor of the predetermined image processing on the image data, based on the image processing information, in the case where the image data are reproduced at a resolution different from the predetermined resolution.

The image data generation method and the image processing methods may be provided by being recorded in a computer-readable recording medium as programs that cause a computer to execute the methods.

According to the image data generation method and the image data generation apparatus of the present invention, the image processing information regarding the predetermined image processing is added to the image data. Therefore, the predetermined image processing that has been carried out on the image data can be easily understood by referring to the image processing information.

Furthermore, according to the image processing methods and the image processing apparatuses of the present invention, the image processing is carried out on the image data based on the image processing information added to the image data when the image data are reproduced at a resolution different from the predetermined resolution. Therefore, the image processing appropriate for reproduction at the resolution different from the predetermined resolution can be carried out on the image data without requiring specialized skills. Consequently, a high-quality image can be reproduced regardless of are solution of an output device. Moreover, since a plurality of image data sets respectively having been subjected to image processing appropriate for a resolution of each output device are not necessary, memory space of a recording medium for storing the image data can be saved.

### BRIEF DESCRIPTION OF THE DRAWINGS

FIG. 1 is a block diagram showing a configuration of an image output system adopting an image data generation apparatus and an image processing apparatus of an embodiment of the present invention;

FIG. 2 is a flow chart showing a procedure carried out in a DPE store;

FIG. 3A is a table showing a relationship between a resolution for reproduction and a parameter, and

FIG. 3B is a graph showing the relationship between the resolution for reproduction and the parameter;

FIG. 4 shows a procedure carried out by recording medium generation means;

FIG. 5 is a block diagram showing a configuration of first reduction means;

FIG. 6 shows a procedure carried out by the first reduction means;

FIG. 7 shows another procedure carried out by the first reduction means;

FIG. 8 shows still another procedure carried out by the first reduction means;

FIG. 9 shows yet another procedure carried out by the first reduction means;

FIG. 10 is a flow chart showing a procedure carried out by a personal computer of a user; and

FIG. 11 shows masks and tables in accordance with values of resolution.

### DESCRIPTION OF THE PREFERRED EMBODIMENT

Hereinafter an embodiment of the present invention will be explained with reference to the accompanying drawings.

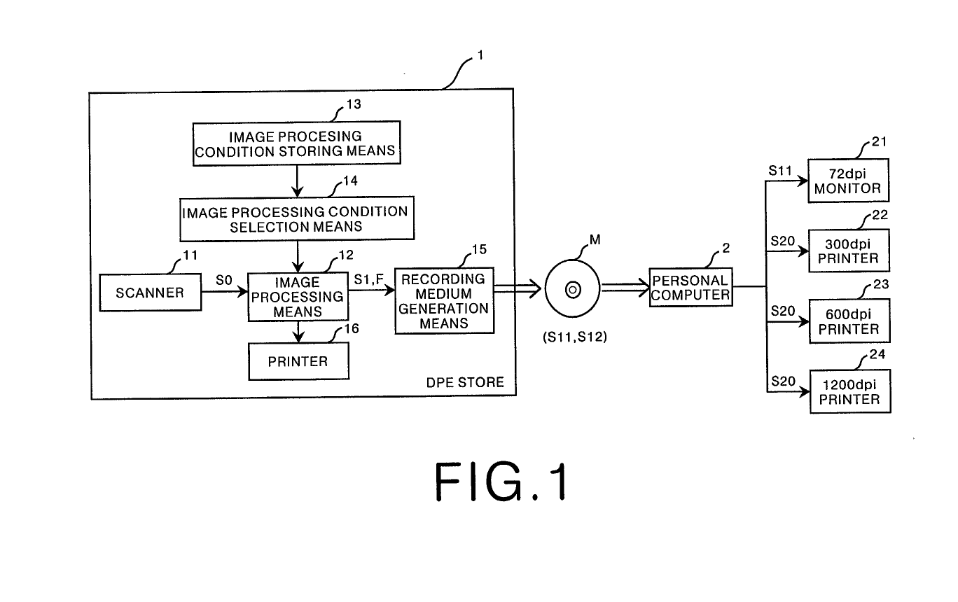

FIG. 1 is a block diagram showing a configuration of an image output system adopting an image data generation apparatus and an image processing apparatus of the embodiment of the present invention. As shown in FIG. 1, the image output system in this embodiment records image data in a recording medium M such as a CD-R at a DPE store 1, and the recording medium M is provided to a user. The user reproduces the image data recorded in the recording medium M by using a personal computer 2.

The DPE store 1 has a scanner 11 for obtaining image data S0 while reading images recorded by the user on a film, image processing means 12 for carrying out image processing on the image data S0 to generate processed image data S1, image processing condition storing means 13 for storing various image processing conditions used by the image processing means 12, image processing condition selection means 14 for selecting one of the image processing conditions used for the image processing on the image data S0 from the image processing conditions stored in the image processing condition storing means 13 as will be explained later, recording medium generation means 15 for generating tagged image data S11 while adding tag information to the image data S1 and for generating the recording medium M while recording the tagged image data S11 therein, and a printer 16 for obtaining a print or an index image print based on the image data S1. The recording medium generation means 15 acts as the adding means of the image data generation apparatus of the present invention. The printer 16 is a 300-dpi printer.

The image processing means 12 carries out sharpness processing on the image data S0. The processed image data S1 are input to the recording medium generation means 15 together with accompanying information F regarding the sharpness processing. The accompanying information F is recorded in the tag information of the tagged image data S11.

The personal computer 2 of the user is connected to output devices such as a monitor 21 for reproducing the image data S11 at a resolution of 72 dpi and printers 22, 23, and 24 for printing the image data S11 at a resolution of 300 dpi, 600 dpi, and 1200 dpi, respectively. The personal computer 2 carries out image processing in accordance with the resolution of each of the output devices, based on the accompanying information F.

Operation of this embodiment will be explained next.

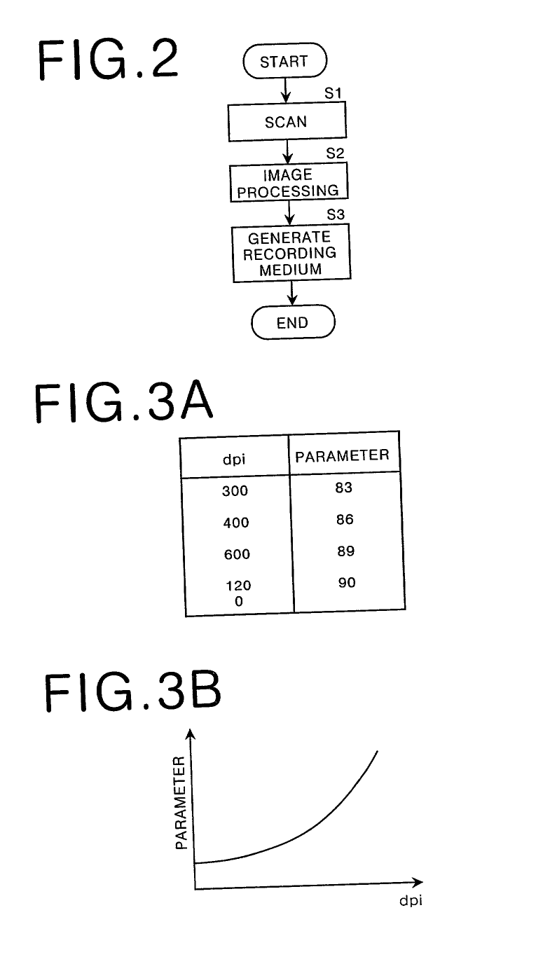

FIG. 2 is a flow chart showing a procedure carried out in the DPE store 1. An operator at the DPE store 1 scans the film with the scanner 11 and obtains the image data S0 while reading the images recorded on the film (Step S1). The image data S0 are subjected to the image processing by the image processing means 12, and the processed image data S1 are obtained (Step S2). At this time, the image processing condition selection means 14 reads the image processing condition from the image processing condition storing means 13 according to how the user uses the image data S11 recorded in the recording medium M, and the sharpness processing is carried out based on the image processing condition that has been read.

For example, if the user mainly uses the image data S11 for reproduction on the monitor 21, the sharpness processing is carried out on the image data S0 to generate the processed image data S1 by using an enhancement factor appropriate for reproduction on the monitor 21. Alternatively, the sharpness processing may be carried out by using a predetermined enhancement factor (such as an enhancement factor appropriate for printing by the printer 16), regardless of the main usage. In this embodiment, the sharpness processing is carried out by using the enhancement factor appropriate for reproduction on the monitor 21 whose resolution is 72 dpi.

The user needs to carry out sharpness processing on the processed image data S1 by using the personal computer 2 in order to obtain a reproduced image in high quality, in the case where the image data S11 recorded in the recording medium M are reproduced by an output device other than the monitor 21. In this embodiment, a parameter necessary for calculation of the enhancement factor of the sharpness processing on the image data S11 to be carried out by the personal computer 2 is input to the recording medium generation means 15 as the accompanying information F, together with the image data S1. The recording medium generation means 15 generates the tagged image data S11 and records the accompanying information F in the tag information. In this manner, the image data S11 are recorded in the recording medium M (Step S3). Since each of the printers 22, 23, and 24 owned by the user has the resolution of 300, 600, and 1200 dpi, respectively, the parameter necessary for calculation of the enhancement factor used in the sharpness processing on the image data S11 appropriate for printing at the resolution (300, 600 and 1200 dpi) is used as the accompanying information F. More specifically, as shown by FIG. 3A, a table showing a relationship between the resolution for reproduction and the parameter is used as the accompanying information F. A graph showing the relationship between the resolution and the parameter as in FIG. 3B may be used as the accompanying information F, instead of the table.

Hereinafter, processing carried out by the recording medium generation means 15 will be explained in detail. In this embodiment, the file format for the image data S1 is assumed to be 4-Base JPEG. The recording medium generation means 15 generates from the image data S1 the image data S11 in a 4-Base Exif format and image data S12 in a 1-Base Exif format that represents a smaller image size than the image data of 4-Base. The image data S11 and the image data S12 are recorded in the recording medium M. The recording medium generation means 15 generates index image data used for generation of the index image print.

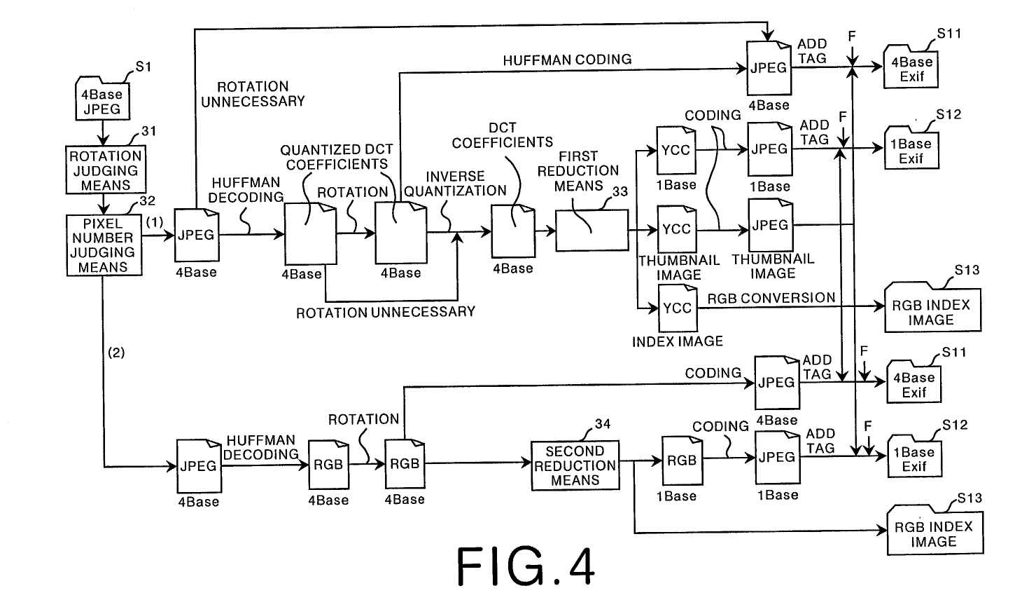

FIG. 4 shows the processing carried out by the recording medium generation means 15. Rotation judging means 31 judges whether or not rotation is necessary for viewing the images represented by the image data S1 in proper orientations. In other words, since the user uses a camera for photographing in the portrait orientation or in the landscape orientation depending on composition, the film records the images in the landscape orientation that can be viewed as they are, and the images in the portrait orientation that need to be viewed after being rotated by 90 degrees.

Since the scanner 11 reads the images from the film in the landscape orientation, the portrait-orientation images would be reproduced in the landscape orientation at the time of reproduction by the user of the image data S11 recorded in the recording medium M, in the case where the image data S1 representing the portrait-orientation images were generated and recorded in the recording medium M without rotation carried out thereon. For this reason, in this embodiment, the rotation judging means 31 judges whether or not rotation is necessary in order to record in the recording medium M the portrait-orientation images in the portrait orientation by carrying out the rotation by 90 degrees. If the rotation judging means judges the rotation to be necessary, the rotation is carried out.

Pixel number judging means 32 judges whether or not the number of pixels in each of the images represented by the image data S1 is a multiple of 16 in the vertical direction and in the horizontal direction. In general, image data of a JPEG format cannot be subjected to rotation without conversion into RGB data through decoding that comprises Huffman decoding, inverse quantization, inverse DCT transformation, and YCC-RGB conversion. However, in the case where the number of pixels is a multiple of 16 in the vertical direction and in the horizontal direction of an image represented by JPEG image data, it is known that rotation can be carried out on quantized DCT coefficients obtained by Huffman decoding. Therefore, in this embodiment, the pixel number judging means 32 judges whether or not the number of pixels in each of the images represented by the image data S1 is a multiple of 16 in the horizontal direction and in the vertical direction. If the number of pixels is judged to be a multiple in both directions, rotation is carried out without decoding into RGB data, in order to shorten an operation time.

In the case where the rotation judging means 31 has judged the rotation to be necessary and the pixel number judging means 32 has judged the number of pixels to be a multiple of 16 in both directions, the processing proceeds to (1) in FIG. 4. In the case where the number of pixels is not a multiple of 16, the processing proceeds to (2) in FIG. 4. In the case where the rotation has been judged to be unnecessary by the rotation judging means 31, the processing also proceeds to (1). The processing in (1) will be explained next.

The image data S1 in the 4-Base JPEG format are subjected to Huffman decoding to be converted into 4-Base quantized DCT coefficients. When the rotation is necessary, the rotation is carried out at this time, and rotated quantized DCT coefficients are obtained. In the case where the image data S11 of the 4-Base Exif format are to be generated, the rotated quantized DCT coefficients are subjected to Huffman coding to generate rotated image data of 4-Base JPEG format. The tag information is added to the 4-Base JPEG image data to generate the 4-Base Exif image data S11. In the case where rotation is unnecessary, the tag information is added to the 4-Base JPEG image data S1 to generate the 4-Base Exif image data S11. The accompanying information F is recorded in the tag information.

In the case where the image data S12 of 1-Base Exif format and the index image data are to be generated, the quantized DCT coefficients with or without rotation are subjected to inverse quantization to generate 4-Base DCT coefficients. The DCT coefficients are reduced while being subjected to inverse DCT carried out by first reduction means 33. In this manner, 1-Base YCC data representing YCC images respectively having the same number of pixels as the images represented by the 1-Base Exif image data S12, YCC thumbnail image data representing thumbnail images respectively having the same number of pixels as thumbnail images represented by thumbnail image data to be recorded as the tag information of the 4-Base Exif image data S11 and the 1-Base Exif image data S12, YCC index image data representing index images respectively having the same number of pixels as index images represented by the index image data are obtained. Hereinafter, the number of pixels in the image data, the YCC data, or the DCT coefficients refers to the number of pixels in each of the images represented by the image data, the YCC data or the DCT coefficients.

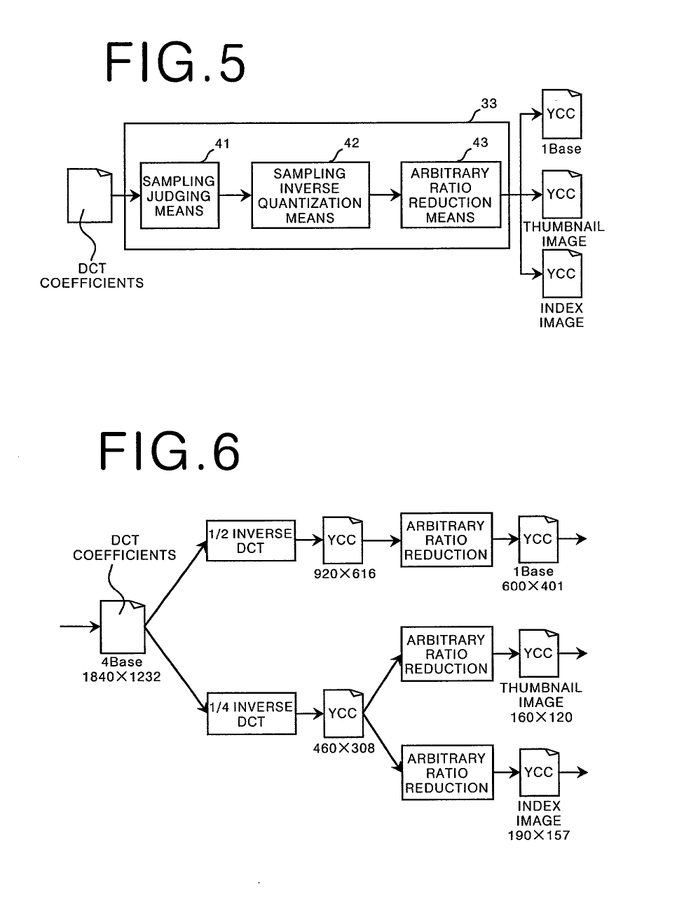

FIG. 5 is a block diagram showing a configuration of the first reduction means 33. As shown in FIG. 5, the first reduction means 33 carries out sampling for reduction and in verse DCT on the 4-Base DCT coefficients to obtain the YCC data having the same number of pixels in the 1-Base Exif image data S12, in the thumbnail image data, and in the index image data. The first reduction means 33 comprises sampling judging means 41, sampling inverse DCT means 42, and arbitrary ratio reduction means 43.

The sampling inverse DCT means 42 carries out sampling while carrying out inverse DCT on the 4-Base DCT coefficients. The sampling inverse DCT means 42 can carry out ½ inverse DCT, ¼ inverse DCT, ⅛ inverse DCT and 1/1 inverse DCT for respectively reducing the number of pixels to ½, ¼, ⅛ and 1/1. The 1/1 inverse DCT results in no change in the number of pixels. The optimal sampling rate varies, depending on a relationship between the number of pixels in the 4-Base DCT coefficients and the number of pixels in the 1-Base Exif image data S12, in the thumbnail image data and in the index image data (hereinafter the number of pixels therein is referred to as a target pixel number). Therefore, the sampling judging means 41 judges the sampling rate for carrying out inverse DCT in the sampling inverse DCT means 42, based on the number of pixels in the 4-Base DCT coefficients and the target pixel number.

The sampling inverse DCT means 42 generates YCC data having the number of pixels depending on the sampling rate. The number of pixels in the YCC data is 1/1, ½, ¼, or ⅛ of the number of pixels in the 4-Base DCT coefficients, and is different from the target pixel number. Therefore, the arbitrary ratio reduction means 43 carries out reduction to cause the YCC data to have the target pixel number. In this manner, the 1-Base YCC data, the YCC thumbnail image data and the YCC index image data are generated.

FIG. 6 shows processing carried out in the first reduction means 33. In FIG. 6, the number of pixels in the 4-Base DCT coefficients is 1840×1232 where the number of pixels in the 1-Base Exif image data S12 is 600×401. The number of pixels in the thumbnail image data is 160×120 and the number of pixels in the index image data is 190×157. In the processing shown in FIG. 6, the sampling rate is set so that the number of pixels sampled is closest to the target pixel number at the time of finding the YCC data having the target pixel number. The YCC data used for finding thumbnail image data are the same as the YCC data used for finding the index image data. According to these rules for the processing in FIG. 6, the sampling judging means 41 judges that ½ inverse DCT should be carried out in order to obtain the 1-Base Exif image data S12 while ¼ inverse DCT should be carriedout for obtaining the thumbnail image data and the index image data. Therefore, ½ inverse DCT and ¼ inverse DCT are carried out in parallel on the 4-Base DCT coefficients to generate ½ sampling YCC data (having 920×616 pixels) and ¼ sampling YCC data (having 460×308 pixels).

The arbitrary ratio reduction processing that causes the number of pixels to become 600×401 is carried out on the ½ sampling YCC data. In this manner, the 1-Base YCC data (having 600×401 pixels) are obtained. Furthermore, the arbitrary ratio reduction processing that causes the number of pixels to become 160×120 and 190×157 is carried out on the ¼ sampling YCC data. In this manner, the YCC thumbnail image data (having 160×120 pixels) and the YCC index image data (having 190×157 pixels) are obtained.

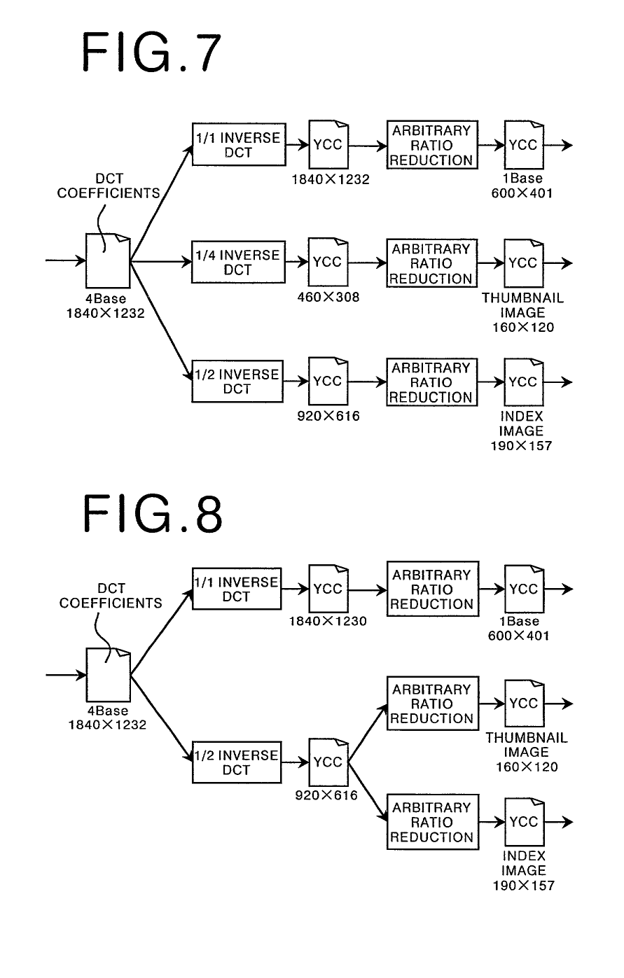

The processing to be carried out by the first reduction means 33 is not limited to the processing shown in FIG. 6, and processing shown in FIG. 7 may be carried out. In the processing shown in FIG. 7, the sampling inverse DCT may be carried out up to double the target pixel number when the YCC data having the target pixel number are obtained. Therefore, according to these rules applied to the processing shown in FIG. 7, the sampling judging means 41 judges that 1/1 inverse DCT should be carried out in order to obtain the 1-Base Exif format image data S12, while ¼ inverse DCT and ½ inverse DCT should be carried out in order to obtain the thumbnail image data and the index image data, respectively. Consequently, 1/1 inverse DCT, ½ inverse DCT, and ¼ inverse DCT are carried out in parallel on the 4-Base DCT coefficients, and the 1/1 sampling YCC data (having 1840×1232 pixels), the ¼ sampling YCC data (having 460×308 pixels) and the ½ sampling YCC data (having the 920×616 pixels) are obtained.

The arbitrary ratio reduction processing that causes the number of pixels to become 600×401 is carried out on the 1/1 sampling YCC data, and the 1-Base YCC data (having 600×401 pixels) are generated. The arbitrary ratio reduction processing that causes the number of pixels to become 160×120 and 190×157 is respectively carried out on the ¼ sampling YCC data and the ½ sampling YCC data, and the YCC thumbnail image data (having 160×120 pixels) and the YCC index image data (having 190×157 pixels) are generated.

Processing shown in FIG. 8 may be carried out instead of the above processing. In the processing shown in FIG. 8, the sampling inverse DCT may be carried out up to double the target pixel number when the YCC data having the target pixel number are obtained. The YCC data used to generate the thumbnail image data are the same as the YCC data used to generate the index image data. Therefore, according to these rules for the processing shown in FIG. 8, the sampling judging means 41 judges that 1/1 inverse DCT should be carried out in order to obtain the 1-BaseExif format image data S12, while ½ inverse DCT should be carried out in order to obtain the thumbnail image data and the index image data. Consequently, 1/1 inverse DCT and ½ inverse DCT are carried out in parallel on the 4-Base DCT coefficients, and the 1/1 sampling YCC data (having 1840×1232 pixels) and the ½ sampling YCC data (having the 920×616 pixels) are obtained.

The arbitrary ratio reduction processing that causes the number of pixels to become 600×401 is carried out on the 1/1 sampling YCC data. In this manner, the 1-Base YCC data (having 600×401 pixels) are obtained. Furthermore, the arbitrary ratio reduction processing that causes the number of pixels to become 160×120 and 190×157 is carried out on the ½ sampling YCC data. In this manner, the YCC thumbnail image data (having 160×120 pixels) and the YCC index image data (having 190×157 pixels) are obtained.

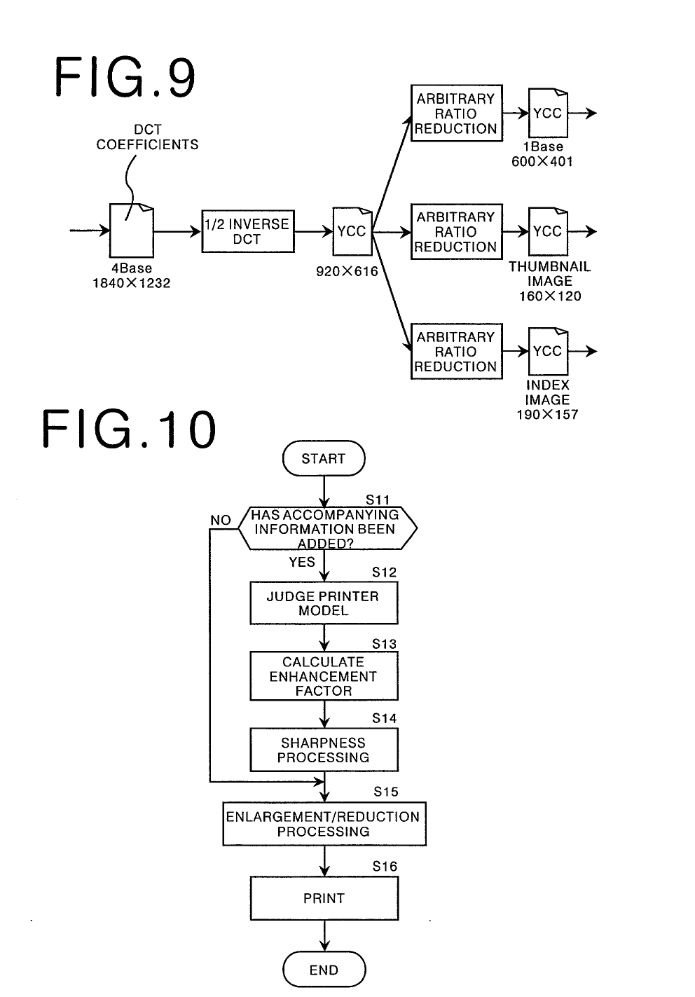

Processing shown in FIG. 9 may be carried out instead of the above processing. In the processing shown in FIG. 9, only the YCC data having been subjected to ½ inverse DCT are used at the time of finding the YCC data having the target number of pixels. Therefore, according to this rule for the processing shown in FIG. 9, the sampling judging means 41 judges that ½ inverse DCT should be carried out in order to obtain the 1-Base Exif format image data S12, the thumbnail image data, and the index image data, respectively. Consequently, ½ inverse DCT is carried out on the 4-Base DCT coefficients and the ½ sampling YCC data (having the 920×616 pixels) are obtained.

The arbitrary ratio reduction processing that causes the number of pixels to become 600×401, 160×120, and 190×157 is carried out respectively on the ½ sampling YCC data, and the 1-Base YCC data (having 600×401 pixels), the YCC thumbnail image data (having 160×120 pixels) and the YCC index image data (having 190×157 pixels) are generated.

After the 1-Base YCC data, the YCC thumbnail image data and the YCC index image data have been generated in the above manner, the 1-Base YCC data are subjected to coding (including DCT transformation, quantization, and Huffman coding) to generate the 1-Base JPEG image data. The tag information is added to the 1-Base JPEG image data to generate the 1-Base Exif format image data S12. The accompanying information F is recorded in the tag information.

The YCC thumbnail image data are subjected to coding (including DCT transformation, quantization, and Huffman coding) to generate thumbnail JPEG image data. The thumbnail JPEG image data are recorded in the tag information of the 4-Base Exif format image data S11 and 1-Base Exif format image data S12.

The YCC index image data are converted into an RGB color space to generate RGB index image data S13. The image data S13 are input to the printer 16 and used for printing the index image print.

The processing (2) will be explained next. The processing (2) is carried out in the case where the number of pixels is not a multiple of 16 in the horizontal and vertical directions of the images presented by the image data S1 and rotation is necessary. The 4-Base JPEG image data S1 are subjected to decoding (including Huffman decoding, inverse quantization, inverse DCT, and YCC-RGB conversion) to generate 4-Base RGB data. The 4-Base RGB data are subjected to rotation, and rotated 4-Base RGB data are obtained. In the case where the 4-Base Exif format image data S11 are to be generated, the rotated 4-Base RGB data are subjected to coding (including RGB-YCC conversion, DCT transformation, quantization, and Huffman coding) to generate rotated 4-Base JPEG image data. The tag information is added to the 4-Base JPEG image data to generate the 4-Base Exif format image data S11. The accompanying information F is recorded in the tag information. The thumbnail image data are generated as in the processing (1), and recorded in the tag information.

In the case where the 1-Base Exif format image data S12 and the index image data are to be generated, second reduction means 34 reduces the 4-Base RGB data. The second reduction means 34 reduces the 4-Base RGB data so as to cause the number of pixels thereof to become the number of pixels in the 1-Base Exif format image data S12 and in the index image data. In this manner, 1-Base RGB data and 1-Base RGB index image data are obtained. The RGB index image data are input to the printer 16 as they are, and used for generating the index image print.

The 1-Base RGB data are subjected to coding (including RGB-YCC conversion, DCT transformation, quantization, and Huffman coding) to generate the 1-Base JPEG image data. The tag information is added to the 1-Base JPEG image data and the 1-Base Exif format image data S12 are obtained. The accompanying information F is recorded in the tag information.

The 4-Base Exif format image data S11 and the 1-Base Exif format image data S12 are recorded in the recording medium M.

The recording medium M recorded with the image data S11 and S12 generated for all the images represented by the image data S1 is provided to the user for reproduction.

The user 1 sets the recording medium M in a recording medium drive (not shown) of the personal computer 2, and reproduces the images by using the monitor 21 or the like. In this embodiment, only the image data S11 are reproduced. The image data S11 recorded in the recording medium M have been subjected to sharpness processing appropriate for reproduction on the monitor 21 having the 72-dpi resolution. Therefore, the images can be reproduced in high quality on the monitor 21 without any further processing.

Meanwhile, since the image data S11 have been subjected to the sharpness processing appropriate for reproduction on the 72-dpi monitor 21, only blurry images can be reproduced if the image data S11 are printed by any one of the printers 22, 23, and 24 having the 300, 600 and 1200 dpi resolution.

Therefore, in the case where the image data S11 are reproduced by any one of the printers 22, 23, and 24, sharpness processing is carried out on the image data S11 by the personal computer 2 in the following manner.

FIG. 10 is a flow chart showing the sharpness processing carried out by the personal computer 2. The user may print not only the image data S11 recorded in the recording medium M with the tag information including the accompanying information F added thereto but also image data not having the accompanying information F in tag information thereof. Therefore, whether or not the accompanying information F is recorded in the tag information of the image data to be reproduced by the user is judged first (Step S11). If a result at Step S11 is affirmative, the image data reproduced by the user are judged to be the image data S11 having the accompanying information F added thereto, and the model of the printer used for reproduction of the image data S11 is then judged (Step S12).

The enhancement factor used for the sharpness processing on the image data S11 is calculated in accordance with the resolution of the printer used for reproduction (Step S13). This calculation is carried out according to Equation (1) below, by using the accompanying information F.

β=(100/p−1)×100 (1)

where β is the enhancement factor (%) and p is a parameter.

For example, in the case where the image data S11 are reproduced by the printer 22 having the 300-dpi resolution, 83 is used as a value of the parameter p (see FIG. 3A). In this case, the enhancement factor β is approximately 20.5%. The sharpness processing is carried out on the image data S11 based on the calculated enhancement factor β to generate processed image data S20 (Step S14). Enlargement/reduction processing is carried out on the image data S20 in accordance with a print size (Step S15), and the image data S20 after the enlargement/reduction processing are printed in the print size by any one of the printers 22, 23, or 24 (Step S16) to end the procedure.

In the case where the image data S20 are reproduced by the 300-dpi resolution printer 22, sharpness is more enhanced than in the case of reproducing the image data S11 as they are with the printer 22, since the enhancement factor in the sharpness processing applied to the image data S20 is larger by approximately 20.5% than the enhancement factor for the image data S11.

In the case where the result at Step S11 is negative, the image data S11 are subjected to the enlargement/reduction processing at Step S15, and printed at Step S16.

As has been described above, according to this embodiment, the parameter necessary for calculation of the sharpness enhancement factor is recorded as the accompanying information F in the tag information of the image data S11. Therefore, even in the case where the image data S11 are reproduced by the printer 22, 23, or 24 having resolutions different from the resolution of the monitor 21, the sharpness processing appropriate for the resolution of the printer used for reproduction can be carried out without the requirement of specialized skills on the image data S11, based on the accompanying information F. Consequently, the images can be reproduced in high quality regardless of the resolution of each of the output devices, without a troublesome operation by the user. Furthermore, image data having been subjected to different sharpness processing according to the resolution of each of the output devices are unnecessary, which leads to reduction in memory space consumption in the recording medium M.

In the above embodiment, the parameter shown in FIG. 3A or 3B is recorded as the accompanying information F in the tag information. However, the personal computer 2 may store the table or the graph shown in FIG. 3A or 3B. In this case, information indicating the resolution aimed at by the sharpness processing carried out on the image data S11 (a value such as 72 dpi representing the resolution, for example) maybe recorded as the accompanying information F in the tag information. In this manner, by referring to the accompanying information F, the output device most appropriate for output of the image data S11 can easily be recognized, based on the sharpness processing carried out thereon. Therefore, in the case where the sharpness processing carried out on the image data S11 is not appropriate for the resolution of the output devices used by the user for reproduction, sharpness processing appropriate for the resolution of the output devices can be carried out easily by using the table or the graph.

The film to be read by the scanner 11 may be an APS film, a 35-mm film, a negative film, or a reversal film, for example. Therefore, the enhancement factor of the optimal sharpness processing varies, depending on the film. For this reason, a plurality of tables or graphs such as the table or the graph shown in FIG. 3A or 3B may be prepared for different films. In this case, a corresponding one of the graphs or tables is recorded as the accompanying information F in the tag information, in accordance with the film.

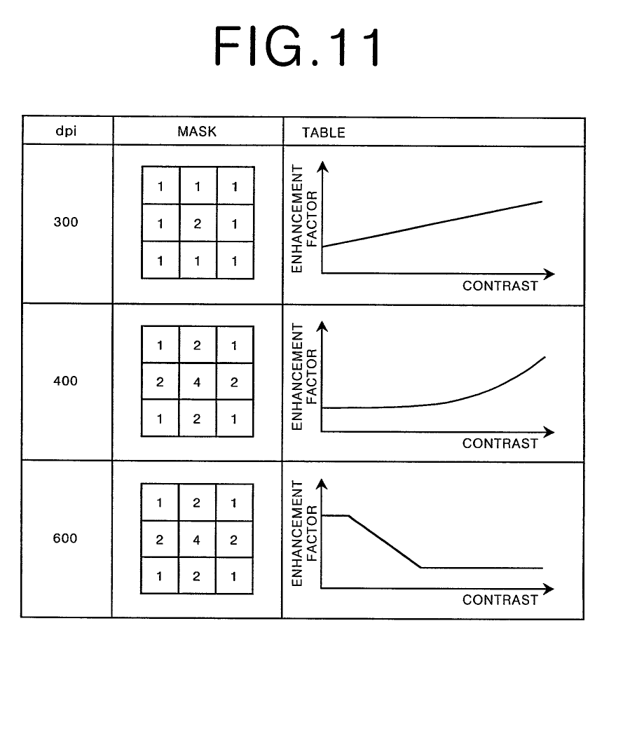

Instead of using the table or the graph shown in FIG. 3A or 3B, a mask and a table for finding the enhancement factor in accordance with the resolution of each of the output devices, as shown in FIG. 11, may be used for sharpness processing. Each of the masks shown in FIG. 11 is a mask necessary for finding unsharp image data of the image data S11 used in the sharpness processing. Each of the tables represents a relationship between the enhancement factor and a difference between the image data S11 and the unsharp image data (the contrast).

In this case, the masks and the tables are stored in the personal computer 2, and information indicating the resolution aimed at by the sharpness processing carried out on the image data S11 (such as 72 dpi) is recorded as the accompanying information F in the tag information. In the case where the output devices owned by the user are the 72-dpi monitor 21 and the 300-dpi printer 22 only, an identifier such as an alphabet or a number referring to the corresponding mask and table may be predetermined for the 300-dpi printer 22 and used as the accompanying information F. In this manner, when the user reproduces the image data S11 with the printer 22, the user refers to the mask and the table corresponding to the identifier and carries out the sharpness processing by using the mask and the table. The mask and the table themselves may also be recorded as the accompanying information F in the tag information.

In the above embodiment, the sharpness processing carried out by the image processing means 12 in the DPE store 1 may be different from the sharpness processing carried out by the personal computer 2 of the user. In this case, the sharpness processing is carried out by the personal computer 2 after changing the accompanying information F to become appropriate for the sharpness processing by the personal computer 2.

In the above embodiment, the accompanying information F is recorded in the tag information. However, the accompanying information F may be recorded in a file separate from files of the image data S11 and S12. In this case, the file of the accompanying information F is recorded in the recording medium M while being related to the files of the image data S11 and S12.

In the above embodiment, the sharpness processing is carried out as the image processing used in this embodiment. However, the image processing is not necessarily limited to the sharpness processing, and tone conversion processing, color conversion processing, and the like in accordance with the resolution of the output devices may also be carried out.

What is claimed is:

1. An image data generation method for generating image data having been subjected to predetermined image processing appropriate for reproduction at a predetermined resolution, the image data generation method comprising the step of:
adding image processing information regarding the predetermined image processing to the image data.

2. An image data generation method as defined in claim 1, wherein the predetermined image processing is sharpness processing.

3. An image data generation method as defined in claim 2, wherein the image processing information is information regarding an enhancement factor used in the sharpness processing.

4. An image processing method for carrying out image processing different from the predetermined image processing on the image data generated by the image data generation method of any one of claims 1 to 3, the image processing method comprising the step of:
carrying out the image processing that is different from the predetermined image processing on the image data based on the image processing information, in the case where the image data are reproduced at a resolution different from the predetermined resolution.

5. An image processing method for carrying out sharpness processing on the image data generated by the image data generation method of claim 3, the image processing method comprising the step of:
carrying out the sharpness processing having an enhancement factor different from the enhancement factor of the sharpness processing of claim 3 on the image data based on the image processing information, in the case where the image data are reproduced at a resolution different from the predetermined resolution.

6. An image data generation apparatus for generating image data having been subjected to predetermined image processing appropriate for reproduction of the image data at a predetermined resolution, the image data generation apparatus comprising:
adding means for adding image processing information regarding the predetermined image processing to the image data.

7. An image data generation apparatus as defined in claim 6, wherein the predetermined image processing is sharpness processing.

8. An image data generation apparatus as defined in claim 7, wherein the image processing information is information regarding an enhancement factor of the sharpness processing.

9. An image processing apparatus comprising processing means for carrying out image processing different from the predetermined image processing on the image data generated by the image data generation apparatus of any one of claims 6 to 8, wherein
the processing means carries out the image processing that is different from the predetermined image processing on the image data based on the image processing information, in the case where the image data are reproduced at a resolution different from the predetermined resolution.

10. An image processing apparatus comprising processing means for carrying out sharpness processing on the image data generated by the image data generation apparatus of claim 8, wherein
the processing means carries out sharpness processing having an enhancement factor different from the enhancement factor of the sharpness processing of claim 8 on the image data, based on the image processing information, in the case where the image data are reproduced at a resolution different from the predetermined resolution.

11. A computer-readable recording medium storing a program that causes a computer to execute an image data generation method for generating image data having been subjected to image processing appropriate for reproduction at a predetermined resolution, the program comprising the procedure of:
adding image processing information regarding the predetermined image processing to the image data.

12. A computer-readable recording medium as defined in claim 11, wherein the predetermined image processing is sharpness processing.

13. A computer-readable recording medium as defined in claim 12, wherein the image processing information is information regarding an enhancement factor used in the sharpness processing.

14. A computer-readable recording medium storing a program that causes a computer to execute an image processing method for carrying out image processing that is different from the predetermined image processing on the image data generated by the image data generation method of any one of claims 1 to 3, the program comprising the procedure of:
carrying out the image processing that is different from the predetermined image processing on the image data based on the image processing information, in the case where the image data are reproduced at a resolution different from the predetermined resolution.

15. A computer-readable recording medium storing a program that causes a computer to execute an image processing method for carrying out sharpness processing on the image data generated by the image data generation method of claim 3, the program comprising the procedure of:
carrying out the sharpness processing having an enhancement factor different from the enhancement factor of the sharpness processing of claim 3 on the image data based on the image processing information, in the case where the image data are reproduced at a resolution different from the predetermined resolution.
